(19) United States
(12) Patent Application Publication
(10) Pub. No.: US 2015/0278785 A1
(43) Pub. Date: Oct. 1, 2015

(54) NCR DIRECT CONNECT (NDC) FLEXIBLE STATE PARAMETER EXTENSION

(71) Applicant: NCR Corporation, Duluth, GA (US)

(72) Inventor: Jan Vesely, Angus (GB)

(73) Assignee: NCR Corporation, Duluth, GA (US)

(21) Appl. No.: 14/229,376

(22) Filed: Mar. 28, 2014

(51) Int. Cl. G06Q 20/18; G06Q 20/10

(52) U.S. Cl. CPC G06Q 20/18; G06Q 20/1085

(57) ABSTRACT

Embodiments for extending functional states of a self-service terminal (SST) are generally described herein. In some embodiments, a state table having flexible parameter states for extending functions of operational states is downloaded to the SST. A state to be extended is selected. A parameter state from the downloaded state table is executed to provide additional functionality to the selected state.

### BACKGROUND

Self-service terminals (SSTs), such as automated teller machines (ATMs) or the like, can be controlled remotely using a host that downloads a transaction flow to the SST. For example, NCR Corporation (trade mark) uses a proprietary message interface to allow a host to control an ATM. This proprietary message interface is called NCR Direct Connect (NDC). Other proprietary message interfaces are also available that enable a remote host to control an ATM and it will be appreciated that the embodiments described herein are not limited to use with the NDC interface. SSTs that are controlled remotely by a host (rather than by an application executing on the SST) are referred to herein as “state-driven SSTs.” As used herein, “state-driven SSTs” do not include any SST that uses a local application that is programmed with its own transaction flow. State-driven SSTs receive a transaction flow in the form of tables (including state, screen, and parameter information) downloaded from a remote host.

The proprietary message interfaces typically operate based on one or more tables of states and screens. When an ATM boots up, it receives the download of any state and screen information from a control application executing on the remote host, e.g., the information, an update for existing information or no information is received by the terminal because the remote hosts decides that no update is necessary. The ATM can then offer transactions to a customer. This is achieved by displaying one or more screens showing options and information and by allowing a user to indicate one or more selections by interacting with a user interface such as by pressing a button or a region of a touchscreen. Once the ATM has gathered the details from the customer (such as card data, PIN data, transaction data, and the like), it then sends a transaction request to the remotely-located control application and receives a response. This response instructs the ATM to perform certain actions, such as dispensing a requested amount of currency notes if the transaction is authorized, or presenting a screen to the customer informing the customer that the transaction has not been approved, in the event that the transaction is declined.

Each ATM stores a state table, which typically comprises the state number, state type, parameters, configuration data, screen numbers, and next state information. In general, where a screen is present it is displayed when the state is entered, the ATM performs the action specified by the state type, and the transaction flow moves to the specified next state. Where a plurality of screens is defined for the same state, then each screen may be displayed in sequence prior to the ATM advancing to the next state.

NDC transaction flow comprises a sequence of NDC States. A number of these NDC States can no longer be functionally extended due to the inability to add new parameters due to their original fixed definition. However, such states cannot be fully re-defined due to the impact on the NDC Host systems.

### SUMMARY

In various embodiments, methods and a system for providing self-configuration of Self-Service Terminals (SST) are presented.

According to an embodiment, a state table having flexible parameter states for extending functions of operational states is downloaded to the SST. A state to be extended is selected. A parameter state from the downloaded state table is executed to provide additional functionality to the selected state.

### BRIEF DESCRIPTION OF THE DRAWINGS

FIG. 1 is a diagram of an example architecture for a Self-Service Terminal (SST) according to an example embodiment;

FIG. 2 illustrates a schematic diagram of a state-driven self-service terminal (SST), in the form of an automated teller machine (ATM), according to one embodiment;

FIG. 3 illustrates a state table having flexible parameter states for extending functions of operational states according to an embodiment; and

FIG. 4 illustrates a flow chart of NDC Flexible State Parameter Extension according to an embodiment.

### DETAILED DESCRIPTION

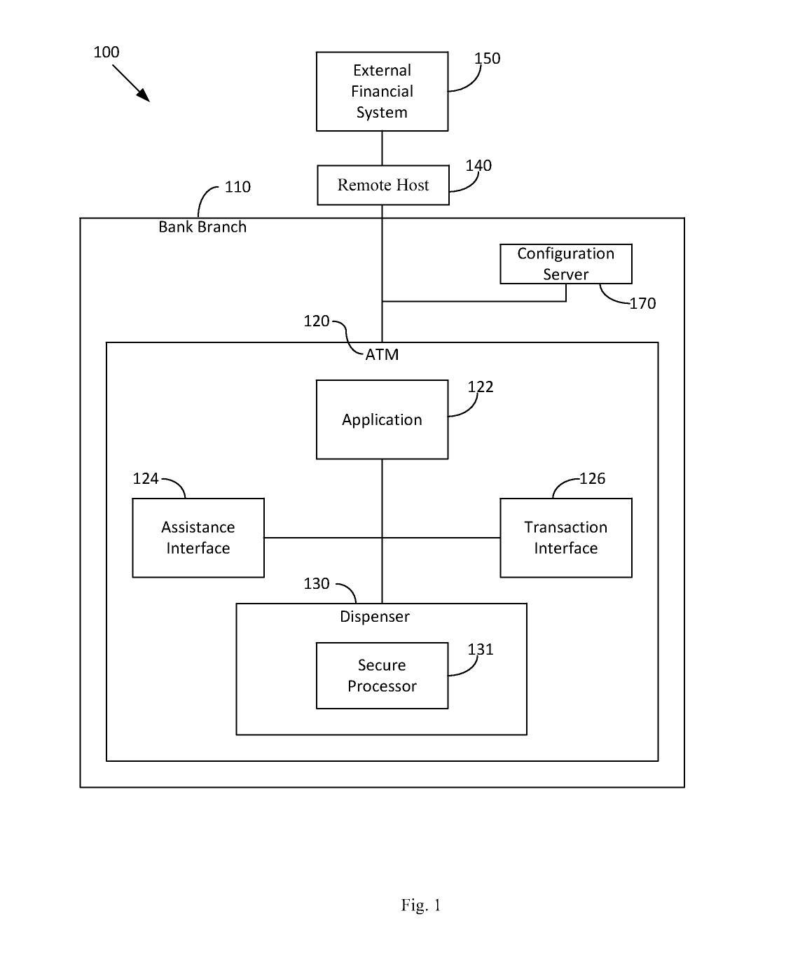

FIG. 1 is a diagram of an example architecture 100 for a Self-Service Terminal (SST) according to an example embodiment. The various components are illustrated and the arrangement of the components is presented for purposes of illustration only. It is to be noted that other arrangements with more or less components are possible without departing from the onsite automated customer assistance teachings presented herein and below.

The techniques, methods, and system presented herein and below for a SST according to an embodiment can be implemented in whole or in part in one, all, or some combination of the components shown with the architecture 100. The techniques and methods are programmed as executable instructions in memory and/or non-transitory computer-readable storage media and processed on one or more processors associated with the various components.

The discussion of the architecture 100 is within the context of a banking facility for banking transactions that may be made in person and at Automated Teller Machines (ATMs). It is noted that the architecture 100 is also applicable to any enterprise providing SSTs and in-person customer assistance. Thus, the description that follows below is but one embodiment and it is not intended to limit embodiments to financial transactions at financial facilities.

The example architecture 100 includes a bank branch 110, an Automated Teller Machine (ATM) 120, a branch server 140, and an external financial system 150. The bank branch 110 includes the Automated Teller Machine (ATM) 120 operated by customers, and a branch server 140.

The ATM 120 includes an application 122 and a dispenser 130. The dispenser 130 includes a secure microprocessor 131. The ATM 120 is presented in greatly simplified form and is used to illustrate those portions of components modified for purposes of providing configuration processes via the configuration server 170. The application 122 includes an Application Programming Interface (API) for interacting with the dispenser 130 and the local bank server 140. The application 122 also includes a forward-facing Graphical User Interface (GUI and not shown in the FIG. 1) for interaction to provide NDC flexible state parameters extension and to perform financial transactions with the external financial system 150. The dispenser 130 is coupled to or integrated within the automatic teller machine (ATM) 120 as an independent device. The coupling can be via a Universal Serial Bus (USB) port interface or other port interface. The dispenser 130 includes a dispensing mechanism for dispensing currency to a customer. The dispensing mechanism is capable of counting the currency from available denominations and activating a door for dispensing the counted currency. The dispenser 130 is accessible for interaction through the application 122 API. The dispenser 130 also includes a secure microprocessor 131, which is not accessible to any of the API calls made by the application 122. The secure microprocessor 131 houses cryptographic keys, certificates, and one or more cryptographic algorithms (functions). In some cases, the secure microprocessor 131 is pre-manufactured with the keys, certificates, and functions. In other cases, the keys, certificates, and functions can be installed on the secure microprocessor 131 by removing the dispenser 130 from the ATM 120 and interfacing the dispenser 130 to an independent secure device for installation and initial configuration.

The bank server 140 communicates with the ATM 120, which includes an application 122, an assistance interface 124, a transaction interface 126, a dispenser 130, and a secure processor 131. The bank branch 110 includes areas for customers to access the ATMs 120 to perform self-service financial transactions with an external financial system 150 utilizing the transaction interface 126 of the ATM 120. The bank branch 110 also includes teller stations for customers to walkup and to perform in-person transactions with tellers.

An ATM 120 relies on a great deal of security to protect the consumer and a bank. As a result, the network accessibility to the ATM 120 is very restrictive. In fact, often the enterprise that services the ATM 120 has very limited network access to the ATM 120. One network connection that banks have found acceptable is a local bank server 140 that resides at the bank branch 110 and acts as a transaction proxy between the network connection of the ATM 120 and a financial backend system 150. It is noted that a customer at the bank branch 110 may utilize the bank's ATM 120 but conduct a financial transaction associated with a different bank, such that gateways are used to select the proper external financial system 150 that services the financial transaction. The local bank server 140 (for security reasons) may not see some details of the financial transaction, such as Personal Identification Numbers (PINs) which appear on the local server 140 as encrypted information. However, actions (transaction type, etc.) taken, customer information (customer name, etc.), transaction details (ATM number, etc.) are visible to local bank server 140.

During a transaction by a customer at the ATM 120 (while at the bank branch 110), the customer initiates the transaction (such as by swiping a bank card), which activates the transaction interface 126. A session is created with the external financial system 150. Some data (as discussed above) is decrypted or capable of being decrypted (based on security policies). Each user is authenticated to the local bank server 140 and a wireless secure (encrypted protocols, such as Wired Equivalent Policy (WEP)) communication session with the local bank server 140 is established.

An Application Programming Interface (API) provides automated two-way communication by providing communication with customers at the ATMs 120 by passing communications via an API. The interaction of the components is now discussed with an example to provide NDC flexible state parameter extension for an ATM 120. It is noted that other scenarios are possible without departing from the beneficial teachings provided herein. According to an embodiment, the ATM 120 may read a state table

The ATM 120 is then ready to provide secure end-to-end device authentication between an approving entity (local bank server 140 or external financial system 150) through to the dispenser 130 using extended NDC states. An example situation now follows for illustration.

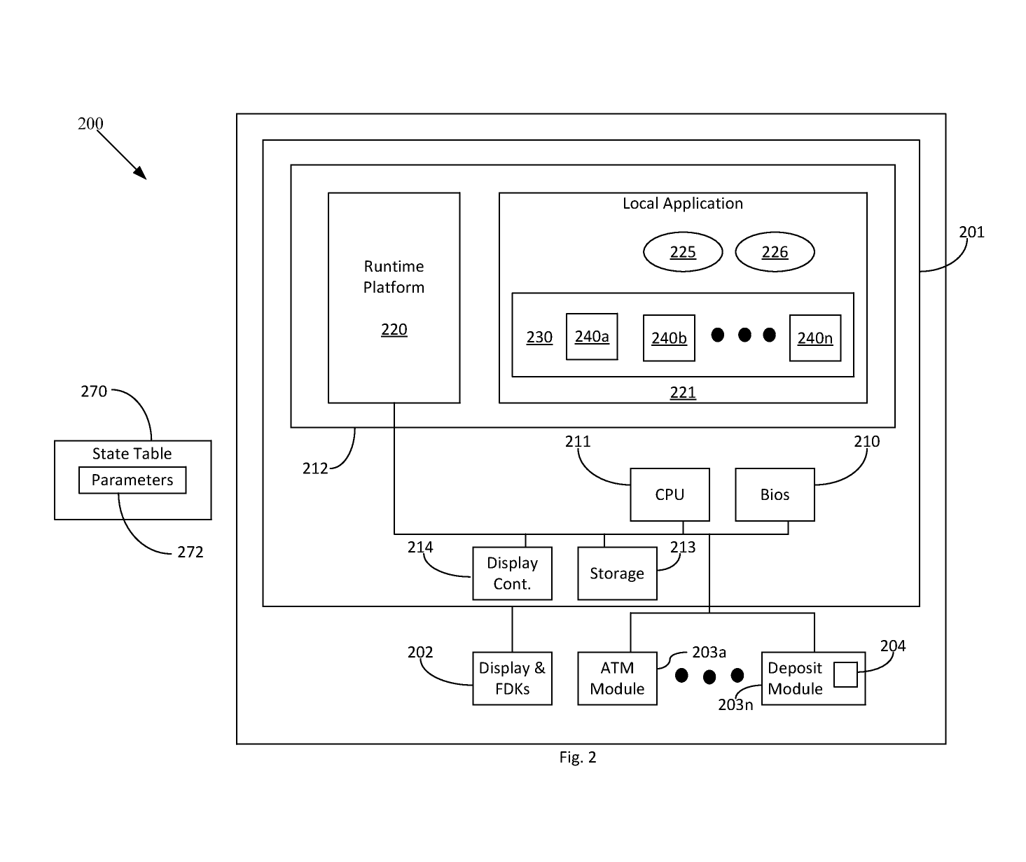

FIG. 2 illustrates a schematic diagram of a state-driven self-service terminal (SST) 200, in the form of an automated teller machine (ATM), according to one embodiment. The ATM 200 comprises a plurality of modules for enabling transactions to be executed and recorded by the ATM 200. These ATM modules comprise: a controller module 201, a customer display module 202, and various other user interface modules and internal ATM modules (labelled 203a to 203n), which are not shown in detail. One of these modules is a depository module 203n having an escrow 204.

The controller 201 comprises a Basic Input Output System (BIOS) 210 stored in non-volatile memory, a microprocessor 211, main memory 212, storage 213 in the form of a magnetic disk drive, and a display controller 214 in the form of a graphics card for controlling the customer display module 202 and any operator panel (not shown) that is present.

When the ATM is powered up, the main memory 212 is loaded with an ATM runtime platform 220 (which functions, inter alia, as a monitoring component) and a local application 221, both of which are stored on the magnetic disk drive 213.

The ATM runtime platform 220 includes: (i) components from an operating system (in this embodiment, Windows XP (trade mark), available from Microsoft Corporation (trade mark)), and (ii) proprietary components. Other components such as the use of Windows 7 or the like could of course be utilized.

The local application 221 (i) presents a sequence of screens on the ATM display module 202 to a customer at the ATM, (ii) collates information from the customer via the ATM modules 202, 203a to 203n and the runtime platform 220 (for example, customer account information from a customer's ATM card, transaction request, transaction amount, and the like), (iii) transmits a transaction request to a remote authorization server (not shown), and (iv) instructs modules within the ATM 200, in response to commands received from the remote authorization server to fulfil the transaction request.

The local application 221 includes a message interface component 225, and a screen control component 226. The local application 221 also stores a state information table 230 (populated with data downloaded from a remote host), including a plurality of screen dictionaries 240a, 240b . . . 240n. To provide extended states for additional functionality to limited NDC states, a state table 270 is used to supply additional parameters 272 to existing limited NCR Direct Connect (NDC) states in support of the need of new and/or additional functionality. Accordingly, more functionality may be introduced to a legacy environment, which is difficult to change otherwise. As opposed to using local registry or Extensible Markup Language (XML) files, the NDC flexible state parameters may be added to the NDC download.

The message interface component 225 implements the message interface such as the NCR Direct Connect (NDC) message interface or the like and enables the ATM 200 to communicate with a control application (not shown) executing on a remote authorization server (not shown).

The screen control component 226 communicates with the runtime platform 220 to receive status information. This status information includes customer selections at the ATM 200, the state of modules 203 within the ATM 200, events occurring within the modules 203 of the ATM 200, and the like.

As shown in more detail in FIG. 2, the customer display module 202 comprises an liquid crystal display (LCD) display panel 200 and eight function display keys (FDKs) (labelled 210a to 210i—there is no 210e) arranged as two columns of four FDKs located opposite each other and on either vertical side of the front of the LCD display panel 200. These allow for customer input. Each key may thus behave as a user button to enable a user to indicate a selection. The ‘button’ can of course have any suitable shape such as circular, square or rectangular or the like.

The state information table 230 comprises details of one or more states used in a state transition flow with each state including one or more details such as the state number, state type, parameters, configuration data, screen numbers, next state information, and screen data. Although referred to herein as a state information table 230, this table 230 actually comprises a series of linked tables (for example, a card read table, a PIN entry table, a cash accept table, and the like), or a table with further tables nested therein. There are typically one or more table entries for each state type, plus other associated tables. This state information may be stored on a particular data structure.

To extend functionality of some states, a state table having additional parameters supplied by the Flexible Parameters State to existing states. This is applicable to the state that immediately executes after (the extended state), i.e., the one in the next state number parameter below. The state parameters provide a general additional extension state and also some more specific parameters, for ease of use.

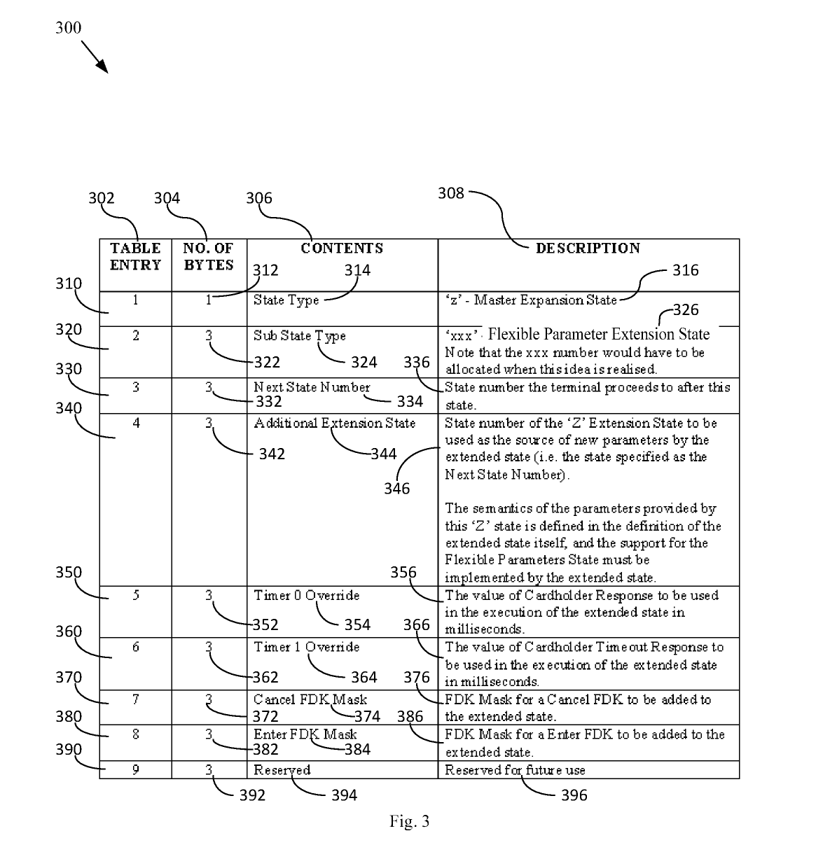

FIG. 3 illustrates a state table 300 having flexible parameter states for extending functions of operational states according to an embodiment. The state table includes columns for table entries 302, the number of bytes for each table entry 304, a content identification 306 and a description for the table entries 308. As shown in the state table 300, a first table entry 310, has a size of 1 byte 312, is for the state type z 314 and is the master expansion state 316. The second table entry 320 has a size of 3 bytes 322, is for the Sub State Type 324 and is ‘xxx’ is the Flexible Parameter Extension State 326, wherein the xxx number may be allocated when this idea is realized. The third table entry 330 has a size of 3 bytes 332, is for the Next State Number 334 and is the state number the terminal proceeds to after this state 336. The fourth table entry 340 has a size of 3 bytes 342, is the Additional Extension State 344 and is the state number of the ‘Z’ Extension state 346 to be used as a source of new parameters by the extended state, i.e., the state specified as the Next State Number. The semantics of the parameters provided by this ‘Z’ state is defined in the definition of the extended state itself, and the support for the Flexible Parameters State may be implemented by the extended state.

The fifth table entry 350 has a size of 3 bytes 352, is the Timer 0 Override 354 and is the value of a cardholder response 356 to be used in the execution of the extended state in seconds. The sixth table entry 360 has a size of 3 bytes 362, is the Timer 1 Override 364 and is the value of cardholder timeout response 366 to be used in the execution of the extended state in seconds. The seventh table entry 370 has a size of 3 bytes 372, is the Cancel FDK Mask 374, wherein a FDK Mask for a Cancel FDK is to be added to the extended state 376. The eighth table entry 380 has a size of 3 bytes 382, is the Enter FDK Mask 384, wherein the FDK Mask for an Enter FDK is to be added to the extended state 386. The ninth table entry 390 has a size of 3 bytes 392, is Reserved 394, wherein it is reserved for future use 396.

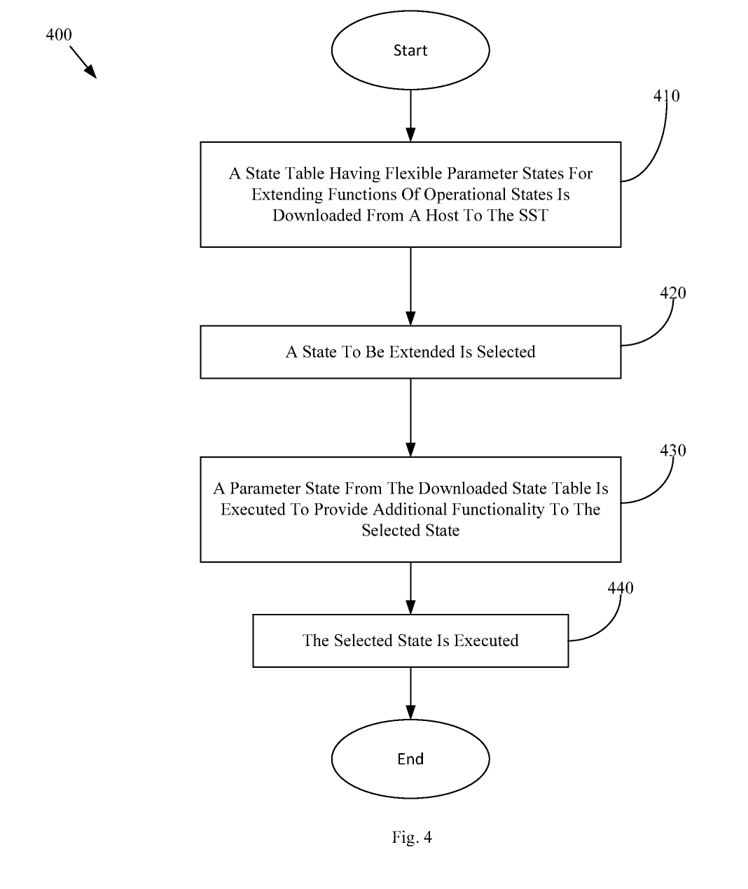

FIG. 4 illustrates a flow chart of NDC Flexible State Parameter Extension 400 according to an embodiment. In FIG. 4, a state table having flexible parameter states for extending functions of operational states is downloaded from a host to the SST 410. A state to be extended is selected 420. A parameter state from the downloaded state table is executed to provide additional functionality to the selected state 430. The selected state is executed 440.

Thus, according to an embodiment, existing states with a fixed definition may be extended with new parameters and hence new functionality. The central transaction processing system (host) does not need to be changed. The addition of flexible parameters state to a host download is not a host change for most hosts; in any case, advanced NCR Direct Connect (ANDC) allows adding such states locally.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth features disclosed herein because embodiments may include a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. A method for extending functional states of a self-service terminal (SST), comprising:
downloading, to the SST, a state table having flexible parameter states for extending functions of operational states;
selecting a state to be extended;
executing a parameter state from the downloaded state table to provide additional functionality to the selected state; and
executing the selected state.

2. The method of claim 1, wherein the downloading, to the SST, a state table further comprises downloading flexible parameter states providing the additional functionality.

3. The method of claim 2, wherein the downloading flexible parameter states providing the additional functionality further comprises arranging one of the flexible parameter states for execution prior to a state to be extended.

4. The method of claim 1, wherein the executing the parameter state from the downloaded state table to provide additional functionality to the selected state further comprises providing state parameters an additional extension state and predetermined specific parameters.

5. The method of claim 1, wherein the downloading a state table having flexible parameter states for extending functions of operational states further comprises downloading a state table having nine table entries.

6. The method of claim 1, wherein the downloading a state table having flexible parameter states for extending functions of operational states further comprises downloading a state table having 25 bytes of data.

7. A method for extending functional states of a self-service terminal (SST), comprising:
downloading, from a host to the SST, a state table having flexible parameter states for extending functions of operational states;
selecting a state to be extended;
executing a parameter state from the downloaded state table prior to the selected state to be extended to provide additional functionality to the selected state to be extended; and
executing the selected state.

8. The method of claim 7, wherein the downloading, from the host to the SST, a state table further comprises downloading flexible parameter states providing the additional functionality.

9. The method of claim 7, wherein the executing the parameter state from the downloaded state table to provide additional functionality to the selected state further comprises providing state parameters an additional extension state and predetermined specific parameters.

10. The method of claim 7, wherein the downloading a state table having flexible parameter states for extending functions of operational states further comprises downloading a state table having nine table entries.

11. The method of claim 7, wherein the downloading a state table having flexible parameter states for extending functions of operational states further comprises downloading a state table having 25 bytes of data.

12. The method of claim 7, wherein the downloading the state table comprises downloading a state table having columns for table entries, a column for a number of bytes for each table entry, a column for content identification and a column for a description of the table entries.

13. The method of claim 7, wherein the downloading the state table comprises downloading a state table having a first table entry with a size of 1 byte for a state type for a master expansion state.

14. The method of claim 7, wherein the downloading the state table comprises downloading a state table having a second through ninth table entry each having a size of 3 bytes.

15. The method of claim 7, wherein the downloading the state table comprises downloading a state table having a second table entry defining a Sub State Type, a third table entry defining a Next State Number for execution after a current state, a fourth table entry defining an Additional Extension State to be used as the source of new parameters by the extended state, a fifth table entry defining a Timer 0 Override for a cardholder response to be used in the execution of the extended state, a sixth table entry defining a Timer 1 Override for a cardholder timeout response to be used in the execution of the extended state, a seventh table entry defining a FDK Mask for a Cancel FDK to be added to the extended state, an eighth table entry defining a FDK Mask for a Enter FDK to be added to the extended state, and a ninth table entry reserved for future use.

16. A Self-Service Terminal (SST), comprising:
an application operable to: (i) execute on the SST, (ii) interact with a dispenser, and (iii) interact with a configuration server in a local bank branch; and
a first state table defining limited NCR Direct Connect (NDC) states;
a second state table having flexible parameter states for extending functions of operational states of the first state table; and
a processor for executing the application to advance NDC transaction flow according to the first and second state table.

17. The SST of claim 16, wherein the second state table further comprises flexible parameter states providing the additional functionality.

18. The SST of claim 17, wherein the flexible parameter states further comprises flexible parameter states arranged for execution prior to a state to be extended.

19. The SST of claim 16, wherein the second state table further comprises state parameters having an additional extension state and predetermined specific parameters.

20. The SST of claim 16, wherein the second state table further comprises a state table having nine table entries.
